(19) United States
(12) Patent Application Publication
(10) Pub. No.: US 2008/0160176 A1
(43) Pub. Date: Jul. 3, 2008

(54) Method of fabricating iridium layer with volatile precursor

(76) Inventors: James M. Blackwell, Portland, OR (US); Adrien R. Lavoie, Beaverton, OR (US); Darryl J. Morrison, Calgary (CA); Bill Barrow, Beaverton, OR (US)

Correspondence Address: INTEL/BLAKELY, 1279 OAKMEAD PARKWAY, SUNNYVALE, CA, 94085-4040, US

(21) Appl. No.: 11/647,984

(22) Filed: Dec. 28, 2006

(51) Int. Cl. B05D 5/12

(52) U.S. Cl. 427/96.8; 423/22

(57) ABSTRACT

An iridium precursor, and an iridium layer from the precursor is described. The Ir(I) in the precursor becomes Ir(III) in a reduction pathway before forming an Ir(0) layer.

### FIELD OF THE INVENTION

The invention relates to the field of iridium layers and precursors for forming such layers particularly in an atomic layer deposition process.

### PRIOR ART AND RELATED ART

The formation of barrier layers, for instance, to prevent the diffusion of conductive materials into a dielectric is important in the fabrication of modern semiconductor integrated circuits. Ideally, the barrier layer should be thin, smooth, easy to deposit and formed at a low temperature. Additionally, the layers should be both oxygen-free and halide-free to prevent contamination of conductive materials.

Iridium is considered a good candidate for a barrier layer. However, currently available precursors have disadvantages that hinder the formation of a suitable film.

Tris(acetylacetonato)iridium(III) has recently been investigated previously as a precursor for iridium metal, see Josell, D.; Bonevich, J. E.; Moffat, T. P.; Aaltonen, T.; Ritala, M.; Leskala, M. Electrochem. Solid State Lett. 2006, 9, C48. Commercially available iridium carbonyl compounds do not have appreciable vapor pressure even at 200° C. to make this a useful source of iridium for ALD or CVD applications.

### BRIEF DESCRIPTION OF THE DRAWINGS

FIG. 1A illustrates a problem associated with the formation of a barrier layer in a narrow opening.

FIG. 1B illustrates an ideal barrier layer in the narrow opening.

FIG. 2 illustrates the steps used in an atomic layer deposition (ALD) process for fabricating an iridium layer.

FIG. 3 illustrates the formation of an iridium precursor.

FIG. 4A illustrates molecules that can be used for the L group of FIG. 3.

FIG. 4B illustrates molecules that can be used for the small X group of FIG. 3.

FIG. 4C illustrates molecules that can be used for the large X group of FIG. 3.

FIG. 5 illustrates the reaction for forming the iridium layer from one of the precursor complexes of FIG. 3.

FIG. 6 illustrates the molecular structure of one embodiment of the precursor.

FIG. 7 illustrates the molecular structure of another embodiment of the precursor.

FIG. 8A is a plan view illustrating the iridium layers formed with the presently disclosed precursor and process.

FIG. 8B is a cross-sectional, elevation view illustrating the iridium layer formed using the presently disclosed precursor and process.

### DETAILED DESCRIPTION

A method of forming an iridium precursor and the use of the precursor in forming an iridium film is described. In the following description, numerous specific molecules and molecular complexes are disclosed to provide a thorough understanding of the present invention. It will be apparent to one skilled in the art, that the present invention may be practiced without these specific embodiments. In other instances, well-known processes are not described in detail, to avoid unnecessarily obscuring the present invention.

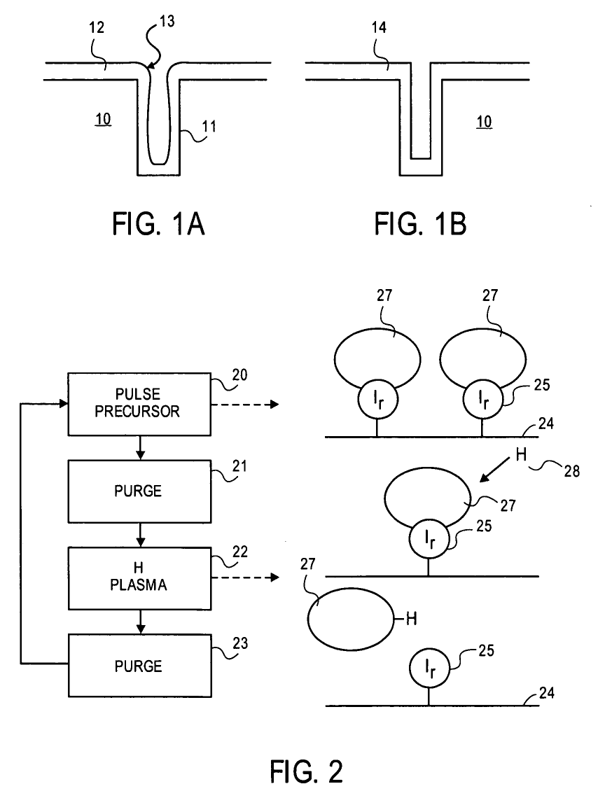

First referring to FIG. 1A, a dielectric layer 10 is illustrated such as a carbon-doped oxide layer. An opening 11 is shown etched in the layer 10. This is typical of the processing used, for instance, in a damascene formed, interconnect layer in an integrated circuit. A barrier layer shown as layer 12 often fabricated from TaN or Ta, provides a barrier preventing diffusion of a subsequently formed conductive material such as Cu or a Cu alloy into the dielectric. Too often, particularly where the opening 11 is narrow, there is a pinching, as shown at 13, of the barrier layer, and a non-uniform thickness within the opening preventing the formation of an ideal conductive layer. As shown in FIG. 1B, ideally the barrier layer 14 should be of a uniform thickness, smooth, thin, and formed at a relatively low temperature (e.g. less than 200° C.).

### Overview of the Iridium Deposition Process

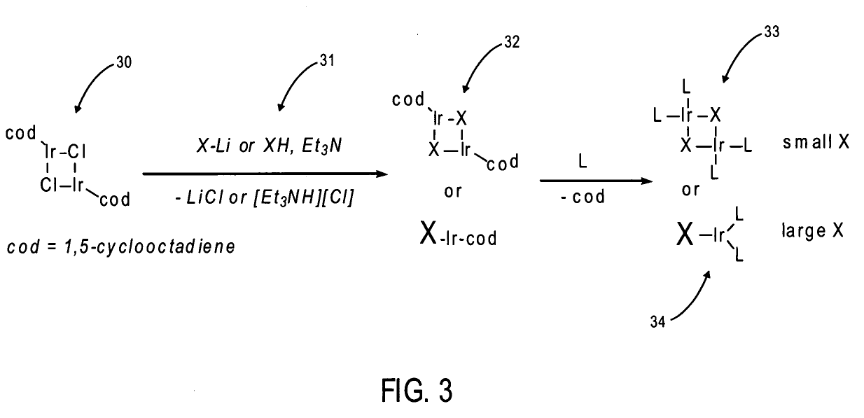

In FIG. 2, a high level view of the ALD process for forming the iridium layer is illustrated. In an ALD chamber, first a pulse of a precursor 20 is injected. As will be described in more detail, the iridium precursor contains carbonyl or isonitrile ligands. These molecular complexes are shown to the right of pulse precursor step 20 as an iridium atom 25 and the remainder of the complex 27. Ir 25 is attached to a surface 24 through physisorption or chemisorption. As will be described in more detail, the precursor is halide-free even though it is synthesized from a halide-containing starting material. Following the precursor pulse 20, the ALD chamber is purged as shown by step 21 of FIG.2.

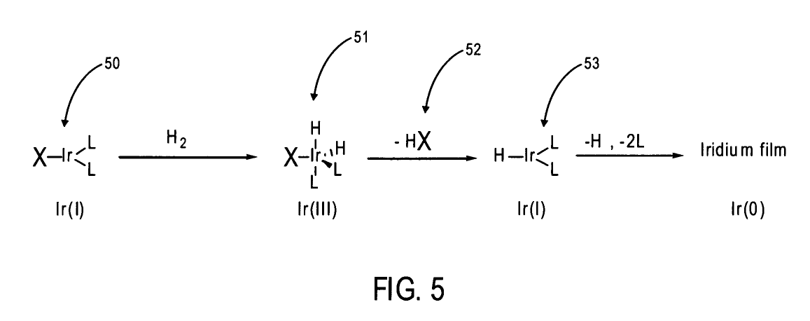

The precursor is designed to react with hydrogen or a co-reactant containing hydrogen such as silane, borane, etc. To the right of the step 20, hydrogen atom 28 is shown as it is injected in a chamber, and finally after it reacts with the precursor complex, leaving only the iridium on the surface 24. This process will be described in more detail in conjunction with FIG. 5.

As illustrated in FIG. 2, following the hydrogen injection step 22, the chamber is typically purged, as shown at step 23. The ALD process is repeated to form an iridium layer of the desired thickness.

### Synthesis of the Iridium Precursor

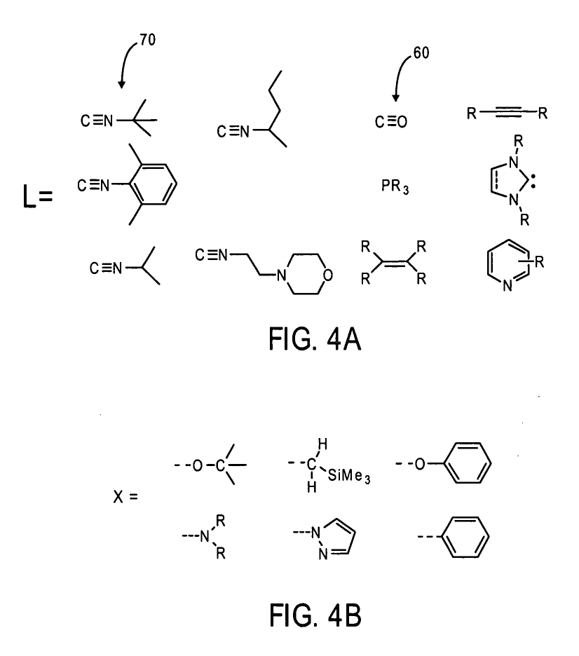

The synthesis of the preferred embodiments of the precursor begins with a commercially available starting material 30, specifically [Cl—Ir(cod)]₂ (cod=1,5-cyclooctadiene) shown in FIG. 3. Both mononuclear and dinuclear complexes may be obtained depending largely on the steric size of the anionic ligand, X. Large X groups favor formation of mononuclear complexes, whereas smaller X groups capable of bridging two metals, leads to dimers. The small X pathway is shown in the upper part of the arrows of FIG. 3, and the large X pathway on the bottom of the arrows of FIG. 3. The first step in synthesizing the precursor is a lithium or amine (triethyl amine) exchange, shown at step 31. This step converts the otherwise chlorine-rich or halide-rich precursor 30 to the halide-free complex 32.

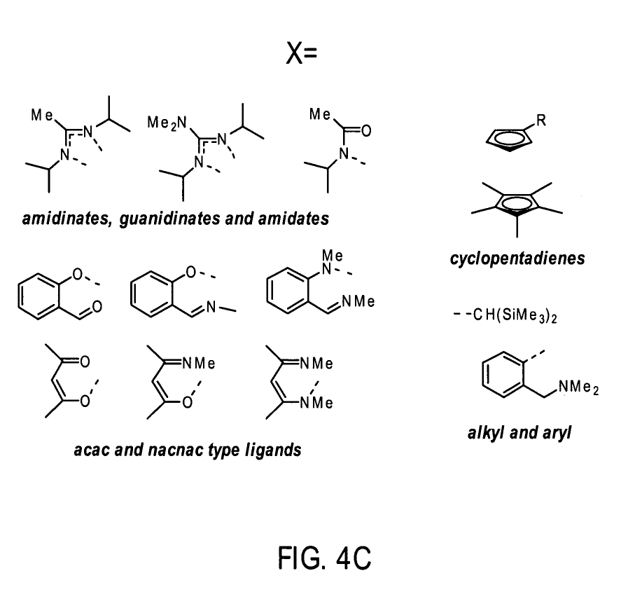

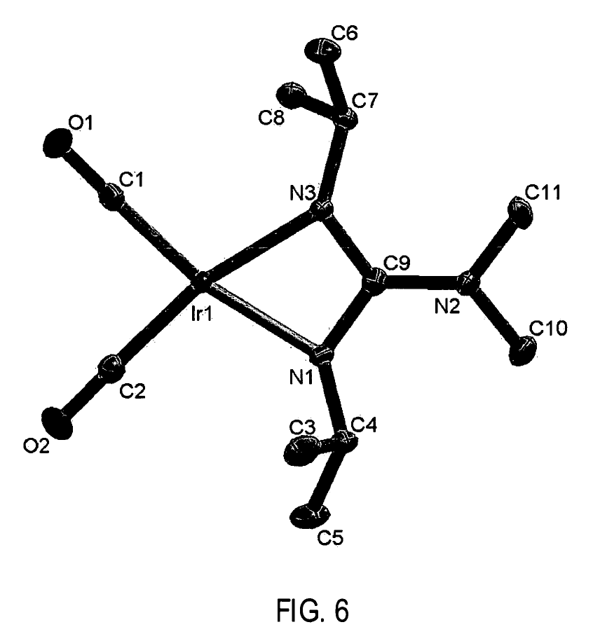

The small and large X groups include, but are not limited to, monoanionic groups based on donating C, N, O, Si, P, and S functionality, as will be described in conjunction with FIGS. 4B and 4C. In FIG. 4B, sample candidates are shown for the small X embodiment of the precursor resulting in a somewhat higher volatility temperature dimer precursor. In FIG. 4C, the somewhat lower temperature volatility embodiment of the precursor using the large X (monomer embodiment) is shown, and as will be described in conjunction with the molecule of FIG. 6, a guanidinate is used.

The precursors 33 and 34 of FIG. 3 are formed in a final step where the cod is replaced with L. The L groups are shown in FIG. 4A and can include CO and isonitriles of general form RNC where R is typically an organic group (e.g. tBu, Ph, 2-pentyl, morpholinoethyl, etc.) Other neutral donor groups such as phosphines (PR₃), alkenes, alkynes, pyridines and N-heterocyclic carbenes may also be used.

The molecular structure [(NMe₂)C(N-i-Pr)₂]Ir(CO)₂, of one embodiment of the precursor 34, as determined by single crystal X-ray diffraction is shown in FIG. 6. This structure incorporates guanidinates of FIG. 4C. This particular molecule also uses the L structure 60 of FIG. 4A.

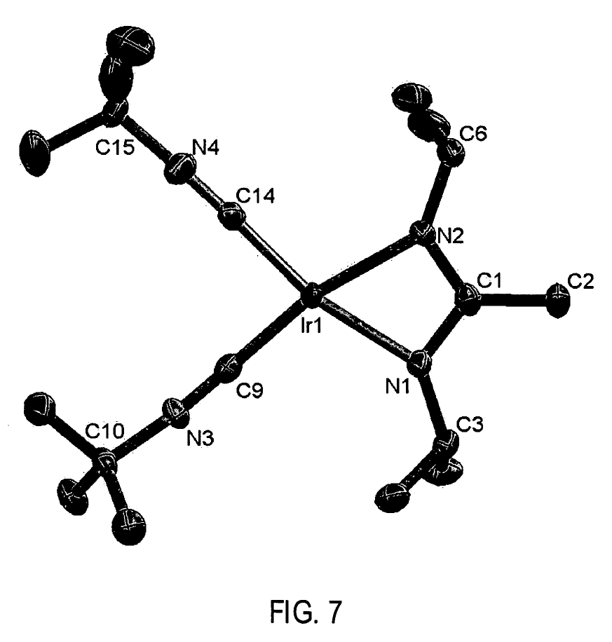

Another embodiment of the precursor, again as determined by single crystal X-ray diffraction is shown in FIG. 7, specifically [(CH₃)C(N-i-Pr)₂]Ir(CN-t-Bu)₂. This, again, is a large X embodiment, this time using the amidinates of FIG. 4C and L70 of FIG. 4A.

### Example of Precursor Synthesis of FIG. 3

Under a nitrogen atmosphere, tetrahydrofuran (20 mL) is added to the mixture of bis(1,5-cyclooctadiene)diiridium(I) dichloride (3.0 g, 4.48 mmol) and Li[NMe₂)C(N-i-Pr)₂] (1.59 g, 8.94 mmol) while cooling the mixture to −78° C. The cold bath is removed and the mixture is warmed to room temperature and stirred for 3 hours. The mixture is filtered to remove lithium chloride and the resulting green/brown filtrate is concentrated to dryness by removal of the tetrahydrofuran in a vacuum. The yellow/brown solid residue is purified by vacuum sublimation to give 3.70 g (88%) of the iridium cyclooctadiene intermediate [(NMe₂)C(N-i-Pr)₂]Ir(cod) as a canary yellow solid (vapor pressure: 60° C./0.02 Torr). An excess of carbon monoxide gas is then bubbled through a CH₂Cl₂ solution (15 mL) of [(NMe₂)C(N-i-Pr)₂]Ir(cod) (2.85 g, 6.07 mmol) at room temperature over 1 hour. The volatile components of the reaction are then removed in a vacuum and the solid residue subjected to vacuum sublimation to yield 2.28 g (90%) of the iridium dicarbonyl compound, [(NMe₂)C(N-i-Pr)₂]Ir(CO)₂, as a green solid (vapor pressure: 35° C./0.023 Torr; m.;. ˜80° C).

### Reactive Pathway for Reduction of Iridium Precursors

The diverse array of iridium(I) precursors 33 and 34 of FIG. 3, react with hydrogen through an oxidation addition pathway. The precursor 50 (a large X precursor) is shown first at 51 after reacting with hydrogen. At 51 both the monomers and dimers of the Ir(I) precursor become monomers of Ir(III). In this process, the complex goes through a higher oxidation state before reaching an ultimate Ir(0) state for the film. As shown at 52, one hydrogen atom and one large X molecule are essentially squeezed out, leaving at 53 the iridium with a remaining H with the Ir(I) state. This unstable molecule, after the release of hydrogen and the Ls, provides a stable iridium layer.

The tandem oxidative addition/reduction elimination pathway of FIG. 5, is not possible for iridium (III) precursors such as Ir(acac)₃ which relies on aggressive chemical conditions (eg high temperatures or oxygen containing coreactants) for liberating the acac groups. Direct use of iridium(III) hydride species as precursors is not possible due to their thermal instability; this strategy creates the iridium(III) species in the reactor.

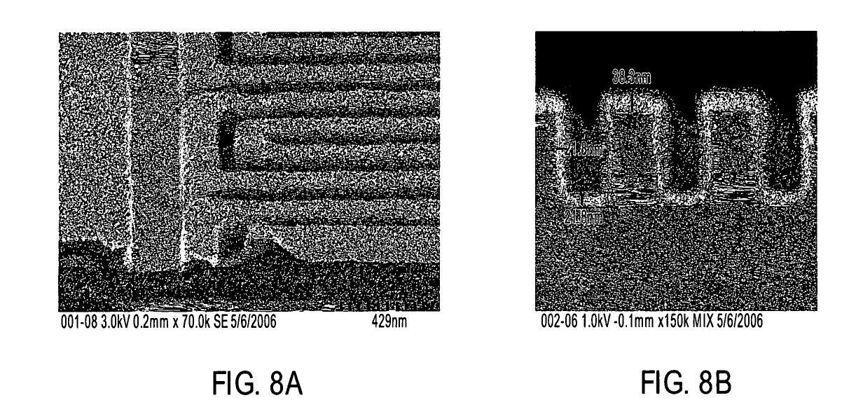

In FIG. 8A and FIG. 8B, the uniformity of the resultant film is shown using the above described precursors. Examining FIG. 8B and comparing it to FIGS. 1A and 1B, it is apparent that a uniform barrier of iridium is achieved.

Thus, a process has been described for providing a volatile, reducible iridium(I) complex synthesized from a commercially available iridium precursor. The described complexes possess diverse ligand properties, allowing the complexes to be effectively used with different co-reactants (H₂, silane, borane, O₂, NH₃, etc.). The tandem in-situ oxidation addition/reduction process provides an improved iridium metallic film.

What is claimed is:

1. A method for forming an iridium layer comprising:
providing a pulse of an iridium(I) precursor comprising a carbonyl or isonitrile moieties; and
providing a pulse of a reducing coreactant to the precursor.

2. The method of claim 1, wherein the iridium(I) goes through a higher oxidation state before forming the iridium layer.

3. The method of claim 2, wherein the co-reactant is selected from the group consisting of: hydrogen, silane and borane.

4. The method of claim 2, wherein the precursor comprises a monomer.

5. The method of claim 2, wherein the precursor comprises a dimer.

6. The method of claim 2, wherein the precursor is halide-free.

7. The method of claim 2, wherein the precursor is synthesized from a halide-rich, cyclooctadiene iridium complex.

8. The method of claim 2, wherein the carbonyl and isonitrile are neutral.

9. A method of forming an iridium precursor comprising:
providing a halide-rich, Ir and cyclooctadiene (cod) complex;
replacing the halide with a negatively charged ligand thereby forming a halide-free complex with a monomer or dimer; and
replacing the cod with neutral ligands comprising CO or isonitriles.

10. The method of claim 9, wherein the providing step comprises:
providing [Cl—Ir(cod)]₂ where cod comprises 1,5-cyclooctadiene.

11. The method of claim 9, including reacting the precursor with hydrogen.

12. The method of claim 11, including forming an iridium layer from the precursor.

13. The method of claim 12, wherein the layer is formed in an atomic layer deposition process.

14. A method of forming an iridium layer comprising:
providing an iridium precursor;
providing a source of hydrogen; and
reacting the precursor and hydrogen such that the iridium in the precursor transitions through a higher oxidation state before forming the layer.

15. The method of claim 14, wherein the iridium is in an Ir(I) state in the precursor, transitions to an Ir(III) state, before becoming Ir(0) in the layer.

16. The method of claim 15, carried out in an atomic layer deposition process.

17. The method of claim 16, wherein the precursor comprises carbonyl or isonitriles.

18. The method of claim 17, wherein the precursor is halide-free.

19. The method of claim 18, wherein the precursor comprises a monomer.

20. The method of claim 18, wherein the precursor comprises a dimer.
